(19) United States
(12) Patent Application Publication
(10) Pub. No.: US 2015/0226397 A1
(43) Pub. Date: Aug. 13, 2015

(54) LIGHT EMITTING MODULE AND ILLUMINATION DEVICE USING THE SAME

(71) Applicant: Panasonic Intellectual Property Management Co., Ltd., Osaka (JP)

(72) Inventors: Hirofumi KONISHI, Osaka (JP); Osamu TANAHASHI, Kyoto (JP); Ryusuke KOTERA, Osaka (JP)

(21) Appl. No.: 14/602,545

(22) Filed: Jan. 22, 2015

(30) Foreign Application Priority Data
Feb. 13, 2014 (JP) 2014-025961

(51) Int. Cl. F21V 3/04; F21V 17/10; F21V 19/00

(52) U.S. Cl. CPC F21V 3/049; F21V 19/004; F21V 17/10

(57) ABSTRACT

A light emitting module includes a plurality of light source units having a rectangular plate shape and a base unit having an elongated rectangular plate shape. The light source units are disposed along a straight line and mounted to the base unit. The light emitting module further includes an optical cover configured to diffuse light emitted from the light source units. The optical cover has a rectangular shape when seen in a plan view and configured to cover the light source units. A length of each of sides of the optical cover and the light source units parallel to short sides of the base unit is substantially equal to a length of each of the short sides of the base unit.

### CROSS-REFERENCE TO RELATED APPLICATION

This application claims priority to Japanese Patent Application No. 2014-025961 filed on Feb. 13, 2014, the entire contents of which are incorporated herein by reference.

### TECHNICAL FIELD

The present disclosure relates to a light emitting module which uses an organic EL element as a light source, and an illumination device using the same.

### BACKGROUND ART

An organic EL (Electro-Luminescence) element is a plate shape light emitting element capable of emitting high-luminance light at a low voltage and capable of emitting light having different colors depending on the kind of organic compounds contained therein. As a light emitting device (light emitting module) using such an organic EL element as a light source, there is known a light emitting device that includes a substrate, an organic EL element provided at the center of the substrate and an electrode pad provided around the organic EL element and configured to supply electric power to the organic EL element (see, e.g., Japanese Unexamined Patent Application Publication No. 2012-182129).

In the light emitting module mentioned above, the region in which the organic EL element is provided serves as a light emission region that emits light. The region which exists around the light emitting region and in which the electrode pad is provided serves as a non-light emission region that does not emit light. For that reason, if a plurality of light emitting modules is disposed adjacent to one another, there is provided a light emission surface in which the light emission region and the non-light emission region are mixed with each other. Thus, luminance unevenness is conspicuous and appearance is deteriorated.

### SUMMARY OF THE INVENTION

In view of the above, the present disclosure provides a light emitting module which uses an organic EL element as a light source and which makes luminance unevenness less conspicuous and makes appearance good even when a plurality of light emitting modules is disposed adjacent to one another.

In accordance with a first aspect of the present invention, there is provided a light emitting module, including: a plurality of light source units having a rectangular plate shape; a base unit having an elongated rectangular plate shape, the light source units disposed along a straight line and mounted to the base unit; and an optical cover configured to diffuse light emitted from the light source units, the optical cover having a rectangular shape when seen in a plan view and configured to cover the light source units, wherein a length of each of sides of the optical cover and the light source units parallel to short sides of the base unit is substantially equal to a length of each of the short sides of the base unit.

Each of the light source units or the base unit may include an attaching portion used in attaching the optical cover, and the optical cover includes an attached portion detachably attached to the attaching portion.

The optical cover is formed into an elongated rectangular shape with short sides thereof extending parallel to the short sides of the base unit and the attached portion is provided in each of long sides of the optical cover.

The attached portion may include a claw portion engaging with the attaching portion, and the claw portion extends along each of the long sides of the optical cover.

An illumination device may include the light emitting module described above.

In accordance with a second aspect of the present invention, there is provided a light emitting module, including:

a light source unit having a rectangular plate shape; and a base unit having a rectangular plate shape, the light source unit removably mounted to the base unit, wherein the base unit includes an attachment surface to which the light source unit is attached, a pair of engaged portions provided to extend along two opposite sides of the attachment surface and used in holding the light source unit, and a through-hole formed in the attachment surface and configured to allow electric wires used in supplying electric power to the light source unit and delivering a dimming signal to the light source unit to pass through the through-hole from a rear side of the attachment surface, the light source unit includes a terminal unit connected to the electric wires and a pair of engaging portions configured to engage with the engaged portions, the terminal unit and the engaging portions provided on a mounting surface of the light source unit to be mounted to the base unit, and the engaging portions are slidable along the engaged portions after the engaging portions engage with the engaged portions.

The terminal unit may include electric wire insertion holes into which electric wires are inserted, and the electric wire insertion holes are opened in a direction parallel to the mounting surface.

The terminal unit may include electric wire insertion holes into which electric wires are inserted, and the electric wire insertion holes are opened in a direction orthogonal to the mounting surface.

The terminal unit may be provided upright on the mounting surface, and the through-hole is disposed at a position corresponding to the terminal unit when the light source unit is mounted to the base unit, the through-hole having a size larger than an outer size of the terminal unit.

The terminal unit may be disposed at a middle position between the engaging portions.

An illumination device may include the light emitting module described above.

In accordance with a third aspect of the present invention, there is provided a light emitting module, including:

a light source unit having a plate shape; and a base unit having an elongated rectangular plate shape, the light source unit removably mounted to the base unit, wherein the light source unit includes a mounting surface to be mounted to the base unit and at least one leaf spring provided on the mounting surface and used in mounting the light source unit to the base unit, the at least one leaf spring has a substantially V-like shape and includes a base portion fixed to the mounting surface and a pair of spring portions extending from the base portion in opposite directions, and the base unit includes an attachment surface to which the light source unit is attached and a through-hole formed in the attachment surface at such a size as to pass therethrough the leaf spring folded such that the spring portions make contact with each other.

The through-hole may be formed into a rectangular shape, and the through-hole includes sides extends parallel to a corresponding side of the base unit when the light source unit is mounted to the base unit.

The spring portions may extend along a longitudinal direction of the base unit when the light source unit is mounted to the base unit.

The leaf spring may further include a pair of bent portions provided at leading ends of the spring portions and bent toward the mounting surface.

The base unit may include a pair of wall portions extending along long sides of the base unit and bent toward the attachment surface side, and the light source unit includes protrusion portions provided on the mounting surface and configured to make contact with the wall portions.

The at least one leaf spring may include a plurality of leaf springs provided in the light source unit.

An illumination device may include the light emitting module described above.

According to the present invention, a portion of the light emitted from the light emission region is diffused by the optical cover and is irradiated toward the front side of the non-light emission region. Therefore, even when a plurality of light emitting modules is disposed adjacent to one another, the luminance unevenness on the light emission surface is less conspicuous and the appearance is made good.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is an exploded perspective view of a light emitting module according to a first embodiment of the present invention.

FIG. 2A is a sectional view taken along line IIA-IIA in FIG. 1, and FIG. 2B is an enlarged view of the region C surrounded by a single-dot chain line in FIG. 2A.

FIG. 3A is an enlarged view of the region A surrounded by a single-dot chain line in FIG. 1, and FIG. 3B is an enlarged view of the region B surrounded by a broken line in FIG. 1.

FIGS. 4A and 4B are views showing an operation by which an attached portion shown in FIG. 3A is attached to an attaching portion shown in FIG. 3B.

FIG. 5 is a plan view showing two light emitting modules disposed adjacent to each other with the long sides of the base units interposed therebetween.

FIG. 6 is a plan view showing two light emitting modules disposed adjacent to each other with the short sides of the base units interposed therebetween.

FIG. 7 is a side sectional view of a light emitting module according to a first modified example of the first embodiment.

FIG. 8 is an exploded perspective view of a light emitting module according to a second modified example of the first embodiment.

FIG. 9A is an enlarged view of the region D surrounded by a single-dot chain line in FIG. 8, and FIG. 9B is an enlarged view of the region E surrounded by a broken line in FIG. 8.

FIGS. 10A and 10B are views showing an operation by which an attached portion shown in FIG. 9A is attached to an attaching portion shown in FIG. 9B.

FIG. 11 is an exploded perspective view showing the light emitting module in which the positions of two light source units are interchanged.

FIG. 12 is an exploded perspective view of a light emitting module according to a third modified example of the first embodiment.

FIG. 13A is an enlarged view of the region F surrounded by a single-dot chain line in FIG. 12, and FIG. 13B is an enlarged view of the region G surrounded by a broken line in FIG. 12.

FIGS. 14A and 14B are views showing an operation by which an attached portion shown in FIG. 13A is attached to an attaching portion shown in FIG. 13B.

FIGS. 15A and 15B are respectively an exploded perspective view and a partially enlarged view of a light emitting module according to a second embodiment.

FIG. 16 is a sectional view taken along line XVI-XVI in FIG. 15A.

FIGS. 17A to 17E are views showing a procedure for attaching the light emitting module to an installation place.

FIGS. 18A and 18B are respectively an exploded perspective view and a partially enlarged view of a light emitting module according to a modified example of the second embodiment.

FIG. 19 is a sectional view taken along line XIX-XIX in FIG. 18.

FIGS. 20A to 20D are views showing a procedure for attaching the light emitting module to an installation place.

FIG. 21 is an exploded perspective view of a light emitting module according to a third embodiment, which is seen from the base unit side.

FIG. 22 is an exploded perspective view of the light emitting module which is seen from the light source unit side.

FIG. 23 is a perspective view of the light emitting module.

FIG. 24 is a sectional view of the light emitting module taken along line XXIV-XXIV in FIG. 23.

FIG. 25 is a plan view showing a plurality of light emitting modules disposed adjacent to one another with the long sides of the base units interposed therebetween.

FIG. 26 is an exploded perspective view of a light emitting module according to a modified example of the third embodiment.

FIG. 27 is a perspective view of the light emitting module.

### DETAILED DESCRIPTION

### First Embodiment

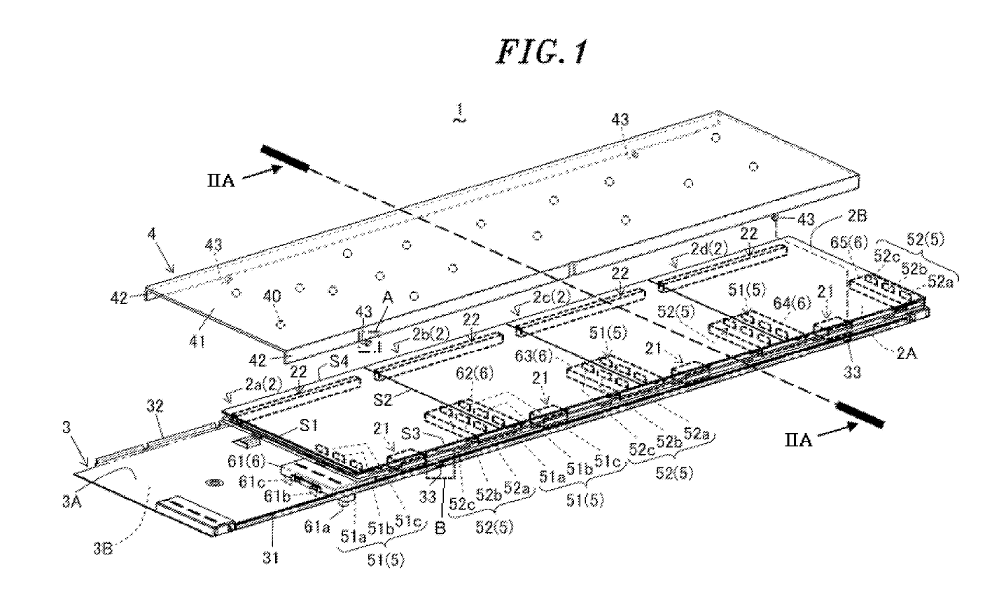

A light emitting module according to a first embodiment of the present invention will now be described with reference to FIGS. 1 to 6. The present light emitting module constitutes an illumination device used in households, stores, etc.

As shown in FIG. 1, the light emitting module 1 includes a plurality of light source units 2, a base unit 3 to which the light source units 2 are removably mounted, and an optical cover 4 for diffusing light emitted from the light source units 2. Each of the light source units 2 is formed into a rectangular plate shape. The base unit 3 is formed into an elongated rectangular plate shape. The optical cover 4 is formed into a rectangular shape when seen in a plan view. The length of each of the sides of the light source units 2 and the optical cover 4 parallel to the short sides of the base unit 3 is substantially equal to the length of each of the short sides of the base unit 3. In the following description, the sides of each of the light source units 2 parallel to the short sides of the base unit 3 will be designated by S1 and S2. The sides of each of the light source units 2 orthogonal to the sides S1 and S2 will be designated by S3 and S4.

In the illustrated example, the light source units 2 include four light source units 2a, 2b, 2c and 2d. The light source units 2a to 2d are equal in size to one another and are disposed adjacent to one another along a straight line with the sides S1 and S2 facing each other. The surface of each of the light source units 2a to 2d facing the base unit 3 serves as a mounting surface 2A which is mounted to the base unit 3. The opposite surface of each of the light source units 2a to 2d from the mounting surface 2A serves as a light emission surface 2B from which light is emitted.

Each of the light source units 2a to 2d includes an engaging portion 21 and an holding portion 22 which are used in mounting each of the light source units 2 to the base unit 3 and terminals 5 which are used in supplying electric power to the light source units 2 and delivering a dimming signal to the light source units 2. The engaging portion 21, the holding portion 22 and the terminals 5 are disposed on the mounting surface 2A. In the illustrated example, one engaging portion 21 is provided at the center of the side S3 and one holding portion 22 is provided at the side S4 to extend along the side S4.

The terminals 5 includes input terminals 51 provided in the side S1 and configured to inputs electric power and a dimming signal from the outside to the light source units 2 and output terminals 52 provided in the side S2 and configured to output electric power and a dimming signal from the light source units 2 to the outside. The input terminals 51 includes an anode terminal 51a and a cathode terminal 51b which are used in supplying electric power from the outside to the light source units 2 and a signal terminal 51c which is used in inputting a dimming signal from the outside to the light source units 2. The output terminals 52 includes an anode terminal 52a and a cathode terminal 52b which are used in supplying electric power from the light source units 2 to the outside and a signal terminal 52c which is used in delivering a dimming signal from the light source units 2 to the outside. In each of the light source units 2a to 2d, the anode terminal 51a and the anode terminal 52a are electrically connected to each other by a wiring pattern (not shown). Similarly, the cathode terminal 51b and the cathode terminal 52b are electrically connected to each other. The signal terminal 51c and the signal terminal 52c are electrically connected to each other.

The surface of the base unit 3 facing the light source units 2 serves as an attachment surface 3A to which the light source units 2 are mounted. The opposite surface of the base unit 3 from the attachment surface 3A serves as an installation surface 3B on which the base unit 3 is attached to the installation place of a ceiling or a wall. The base unit 3 includes engaged portions 31, each of which engages with the engaging portion 21 of each of the light source units 2, and held portions 32, each of which engages with the holding portion 22 of each of the light source units 2. The engaged portions 31 and the held portions 32 are disposed on the attachment surface 3A of the base unit 3. The engaged portions 31 and the held portions 32 are provided along the long sides of the base unit 3 and are formed by bending transverse end portions of the base unit 3 toward the attachment surface 3A. The base unit 3 is formed by, for example, pressing and cutting an aluminum plate or a steel plate having specified rigidity.

The base unit 3 includes a plurality of attaching portions 33 used in attaching the optical cover 4 to the base unit 3. The attaching portions 33 are provided in the engaged portions 31 and the held portions 32. In the illustrated example, two attaching portions 33 are provided in each of the engaged portions 31 and two attaching portions 33 are provided in each of the held portions 32.

The base unit 3 further includes connectors 6 electrically connected to the terminals 5 of the light source units 2. The connectors 6 include an input connector 61 which interconnects the outside and the input terminals 51 of the light source unit 2a, a relay connector 62 which interconnects the light source units 2a and 2b, and a relay connector 63 which interconnects the light source units 2b and 2c. The connectors 6 further include a relay connector 64 which interconnects the light source units 2c and 2d and an end cap 65 which protects the output terminals 52 of the light source unit 2d. The input connector 61, the relay connectors 62 to 64 and the end cap 65 have external surfaces made of an insulating material and cover the terminals 5 such that the terminals 5 are not exposed to the outside. This makes it possible to prevent an electric shock accident and a tracking phenomenon which may otherwise occur when the light source units 2 are mounted to the base unit 3.

The input connector 61 includes an anode line insertion hole 61a and a cathode line insertion hole 61b into which an anode line and a cathode line (not shown) for supplying electric power from the outside to the light source unit 2a are respectively inserted. The input connector 61 further includes a signal line insertion hole 61c into which a signal line (not shown) for inputting a dimming signal from the outside to the light source unit 2a is inserted. The anode line, the cathode line and the signal line inserted into the insertion holes 61a to 61c are electrically connected to the anode terminal 51a, the cathode terminal 51b and the signal terminal 51c, respectively.

The relay connector 62 electrically interconnects the anode terminal 52a of the light source unit 2a and the anode terminal 51a of the light source unit 2b. Similarly, the relay connector 62 electrically interconnects the cathode terminal 52b of the light source unit 2a and the cathode terminal 51b of the light source unit 2b and electrically interconnects the signal terminal 52c of the light source unit 2a and the signal terminal 51c of the light source unit 2b. Thus, the light source units 2a and 2b are electrically connected to each other. Just like the relay connector 62, the relay connector 63 electrically interconnects the light source units 2b and 2c, and the relay connector 64 electrically interconnects the light source units 2c and 2d.

In order to prevent an electric shock accident and a tracking phenomenon, the end cap 65 merely covers and hides the terminals 52a to 52c of the light source unit 2d.

The optical cover 4 covers all the light emission surfaces 2B of the light source units 2a to 2d. The optical cover 4 includes a flat plate portion 41 having an elongated rectangular plate shape provided in a corresponding relationship with the light source units 2a to 2d and a pair of leg portions 42 extending from the longitudinal sides of the flat plate portion 41 in one direction (downward in the illustrated example). The optical cover 4 further includes a plurality of attach ed portions 43 provided at the lower ends of the leg portions 42 and detachably attached to the attaching portions 33 of the base unit 3 and a diffusing agent 40 dispersed in the flat plate portion 41 to diffuse light. The diffusing agent 40 is composed of, e.g., particulate titanium dioxide, particulate silicon dioxide or particulate ceramic. The optical cover 4 is formed by using, as a base material, a resin having a light transmitting property and an electrical insulating property, e.g., a polycarbonate resin, an acryl resin or a polystyrene resin. The optical cover 4 is not limited to the configuration in which light is diffused by adding the diffusing agent 40 but may have a configuration in which light is diffused by forming fine irregularities on the surface of the flat plate portion 41 or by bonding a light-diffusing sheet to the surface of the flat plate portion 41.

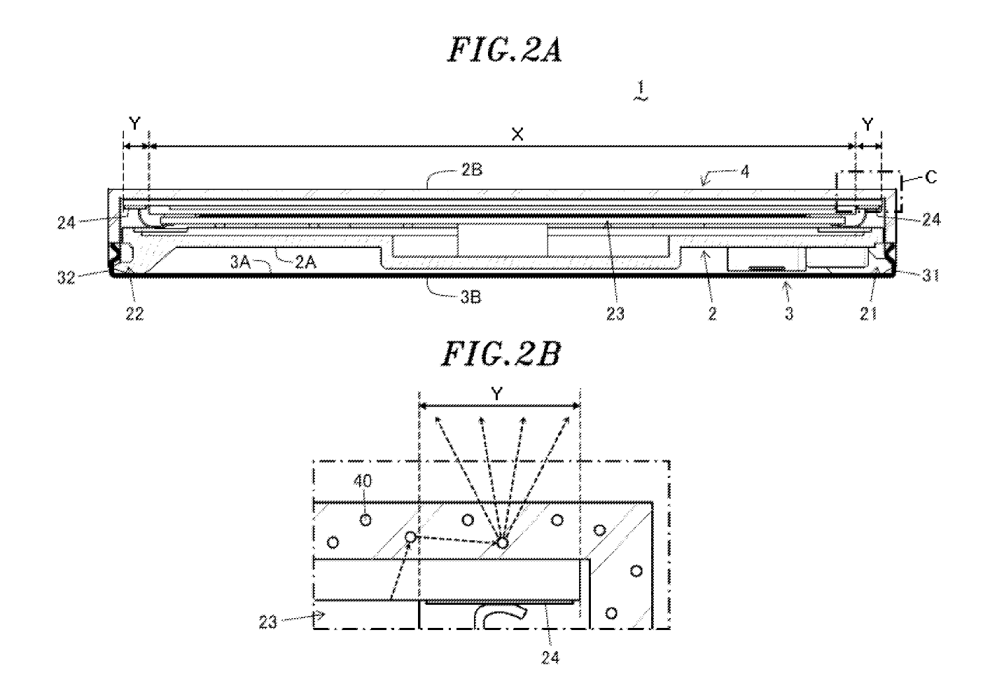

As shown in FIG. 2A, each of the light source units 2 includes an organic EL element 23 having a plate shape and an electrode pad 24 disposed around the organic EL element 23 and configured to supply electric power to the organic EL element 23. The region X where the organic EL element 23 is provided serves as a light emission region that emits light. The region Y where the electrode pad 24 is provided serves as a non-light emission region that does not emit light. As shown in FIG. 2B, a portion of the light (indicated by broken lines) emitted from the organic EL element 23 is diffused by the diffusing agent 40 and is irradiated toward the front side of the non-light emission region Y. Thus, the difference between the luminance of the light irradiated from the light emission region X and the luminance of the light irradiated from the non-light emission region Y becomes small. For that reason, the luminance unevenness in the light emission surface 2B is less conspicuous and the appearance of the light emitting module 1 is made good.

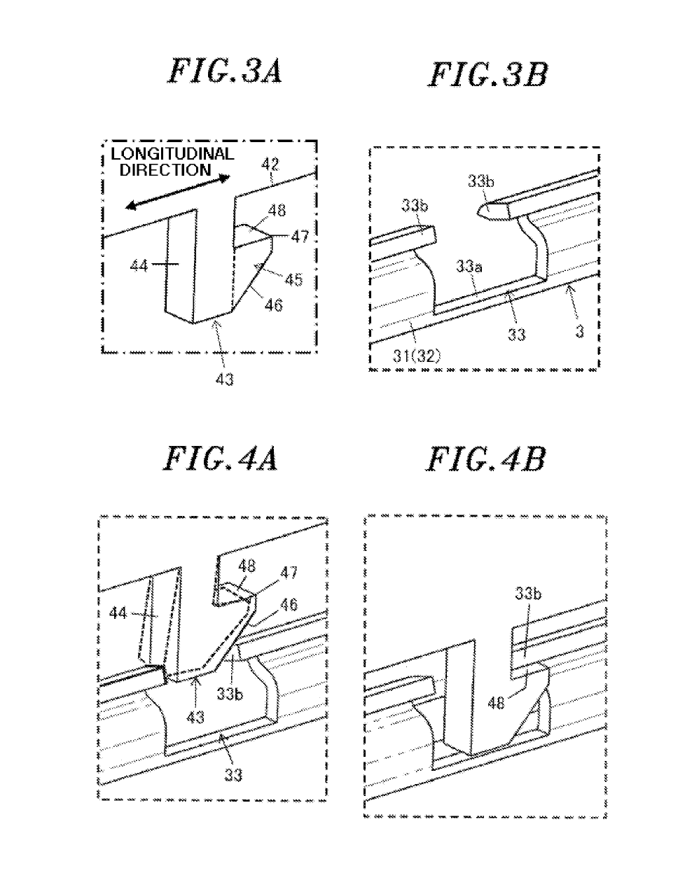

As shown in FIG. 3A, each of the attached portions 43 includes a columnar base portion 44 extending downward from each of the leg portions 42 and a claw portion 45 provided at the lower end of the base portion 44 and configured to engage with each of the attaching portions 33. The base portion 44 is made of a material which can be elastically deformed when a specified stress is applied thereto. The claw portion 45 includes a slant section 46 extending along the longitudinal direction of the optical cover 4 and inclined to extend obliquely upward from the lower end of the base portion 44 and a locking section 48 extending from the upper end 47 of the slant section 46 toward the base portion 44 and locked to each of the attaching portions 33 of the base unit 3. The two attached portions 43 provided in each of the longitudinal sides of the optical cover 4 are disposed such that the claw portions 45 of the two attached portions 43 face each other (see FIG. 1).

As shown in FIG. 3B, each of the attaching portions 33 includes a rectangular notch 33a provided in each of the engaged portions 31 (or the held portions 32) and a pair of extension portions 33b extending from the upper end of the notch 33a along the longitudinal direction so as to partially close the notch 33a.

As shown in FIG. 4A, when attaching each of the attached portions 43 to each of the attaching portions 33, each of the attached portions 43 is first moved closer to each of the attaching portions 33 such that the slant section 46 of each of the attached portions 43 makes contact with one of the extension portions 33b. Consequently, the slant section 46 is pressed by one of the extension portions 33b and the base portion 44 is elastically deformed. In other words, each of the attached portions 43 is elastically deformed as indicated by a broken line. As a result, each of the attached portions 43 is pushed into each of the attaching portions 33. At the time point when the upper end 47 of the slant section 46 goes over one of the extension portions 33b, each of the elastically-deformed attached portions 43 restores the original shape. Thus, as shown in FIG. 4B, the locking section 48 engages with one of the extension portions 33b.

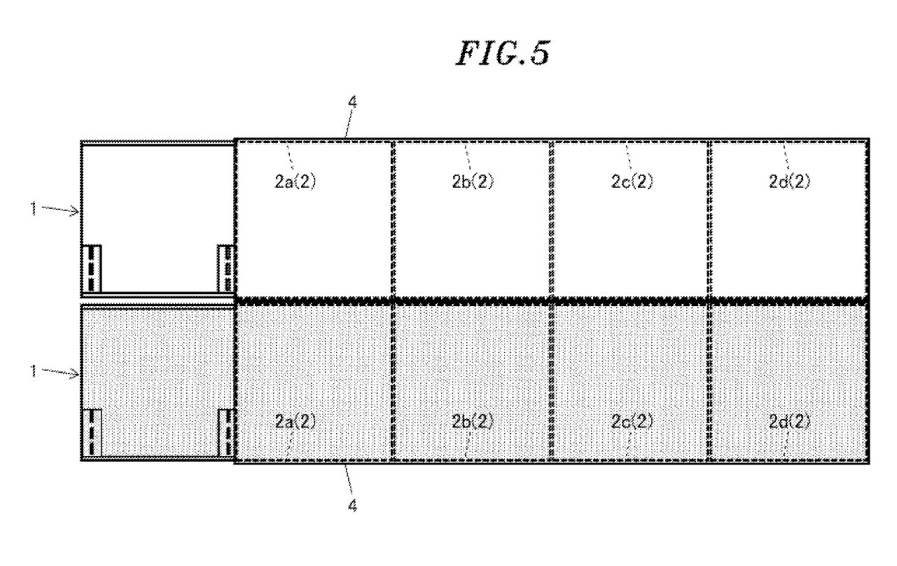

In the light emitting module 1 configured as above, the length of the short side of the base unit 3 and the length of the short sides of the optical cover 4 are substantially equal to the length of the sides S1 and S2 of the light source units 2. For that reason, if two light emitting modules 1 (one of which is indicated by dots) are disposed adjacent to each other with the long sides interposed therebetween as shown in FIG. 5, the light source units 2 of one of the light emitting modules 1 and the light source units 2 of the other light emitting module 1 adjoin each other. This makes it possible to reduce a non-light emission region which may be generated between the light emitting modules 1. Since the light emitted from the respective light source units 2 is diffused by the optical cover 4 and is irradiated even toward the front side of the non-light emission region, it is possible obtain a uniform light irradiation surface in the two light emitting modules 1 as a whole. This makes it possible to ameliorate the appearance of the light emitting module 1 and the appearance of the illumination device provided with the light emitting module 1.

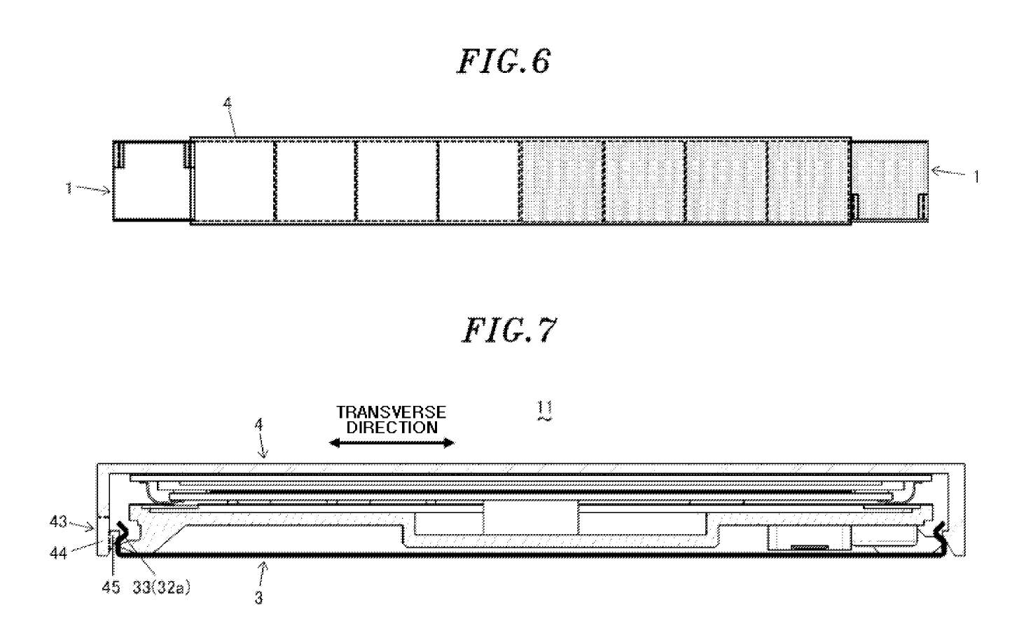

If two light emitting modules 1 (one of which is indicated by dots) are disposed adjacent to each other with the short sides interposed therebetween as shown in FIG. 6, the optical cover 4 is disposed so as to straddle the two light emitting modules 1, thereby covering all the light source units 2. Thus, the boundary between the adjoining light source units 2 of each of the light emitting modules 1 can be made unnoticeable. Likewise, the boundary between the adjoining light emitting modules 1 can be made unnoticeable.

The optical cover 4 is detachably attached to the base unit 3. Therefore, for example, an optical cover 4 containing a dimming phosphor and a colored optical cover 4 may be prepared and may be interchangeably attached depending on the use of the light emitting module 1. Since two attached portions 43 are provided in each of the long sides of the optical cover 4, it becomes easy to attach the optical cover 4 to the base unit 3. Furthermore, it becomes possible to enhance the attachment stability of the optical cover 4. Since the claw portion 45 of each of the attached portions 43 extends along each of the long sides of the optical cover 4, the attached portions 43 can be provided by making the short sides of the optical cover 4 as short as possible. This makes it possible to prevent generation of a non-light emission region.

Next, a light emitting module according to a first modified example of the aforementioned embodiment will be described with reference to FIG. 7. A light emitting module 11 is based on the aforementioned light emitting module 1 with the shape of the attached portions 43 and the shape of the attaching portions 33 changed. In the light emitting module 11, the claw portion 45 of each of the attached portions 43 extends inward along the transverse direction of the optical cover 4. The attaching portion 33 is composed of the outer surfaces of the engaged portion 31 and the held portion 32 which are formed by bending the base unit 3. Thus, unlike the aforementioned light emitting module 1, it is not necessary that the attaching portion 33 be provided by forming notch in the engaged portion 31 and the held portion 32 of the base unit 3. Accordingly, the optical cover 4 can be attached to the base unit 3 using a configuration simpler than the configuration of the aforementioned light emitting module 1.

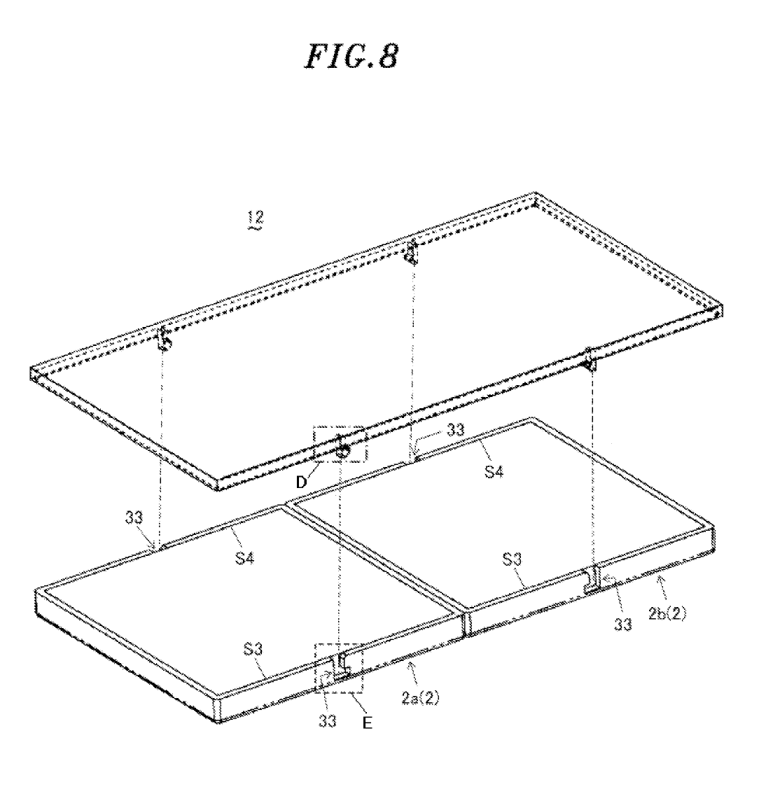

Next, a light emitting module according to a second modified example of the aforementioned embodiment will be described with reference to FIGS. 8 to 10B. As shown in FIG. 8, a light emitting module 12 is based on the aforementioned light emitting module 1 with the shape of the attaching portions 33 changed. In the light emitting module 12, the attaching portions 33 are formed by cutting the side surfaces of the sides S3 and S4 of the light source units 2. In the illustrated example, the attaching portions 33 are formed in the sides S3 and S4 of the light source units 2a and 2b, one in each side. The base unit 3 is not shown in FIG. 8.

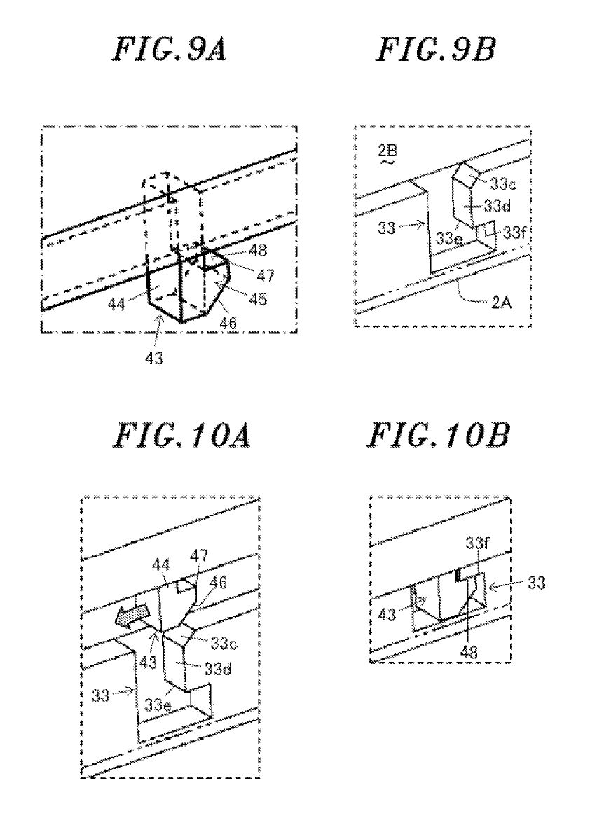

As shown in FIG. 9A, the attached portions 43 of the light emitting module 12 have the same shape as the shape of the attached portions 43 of the aforementioned light emitting module 1. As illustrated in FIG. 9B, each of the attaching portions 33 includes a slant section 33c inclined at the same inclination as the inclination of the slant section 46 of each of the attached portions 43 with respect to the light emission surface 2B and a straight section 33d provided continuously with the slant section 33c so as to extend toward the mounting surface 2A (downward in the illustrated example). Each of the attaching portions 33 further includes a locking section 33f formed by cutting from the lower end 33e of the straight section 33d toward the slant section 33c and configured to engage with the locking section 48 of each of the attached portions 43.

As shown in FIG. 10A, when attaching the attached portion 43 to the attaching portion 33, the attached portion 43 is first moved closer to the attaching portion 33 such that the slant section 46 of the attached portion 43 makes contact with the slant section 33c of the attaching portion 33. Then, the slant section 46 is pressed by the slant section 33c (see the pressing direction indicated by an arrow) and the base portion 44 (the attached portion 43) is elastically deformed. Thus, the attached portion 43 is pushed into the attaching portion 33. At the time point when the upper end 47 of the slant section 46 goes over the lower end 33e of the straight section 33d, the elastically-deformed attached portion 43 restores the original shape and, as shown in FIG. 10B, the locking section 48 of the attached portion 43 engages with the locking section 33f of the attaching portion 33.

According to the light emitting module 12 configured as above, it is possible to obtain the same effects as provided by the aforementioned light emitting module 1.

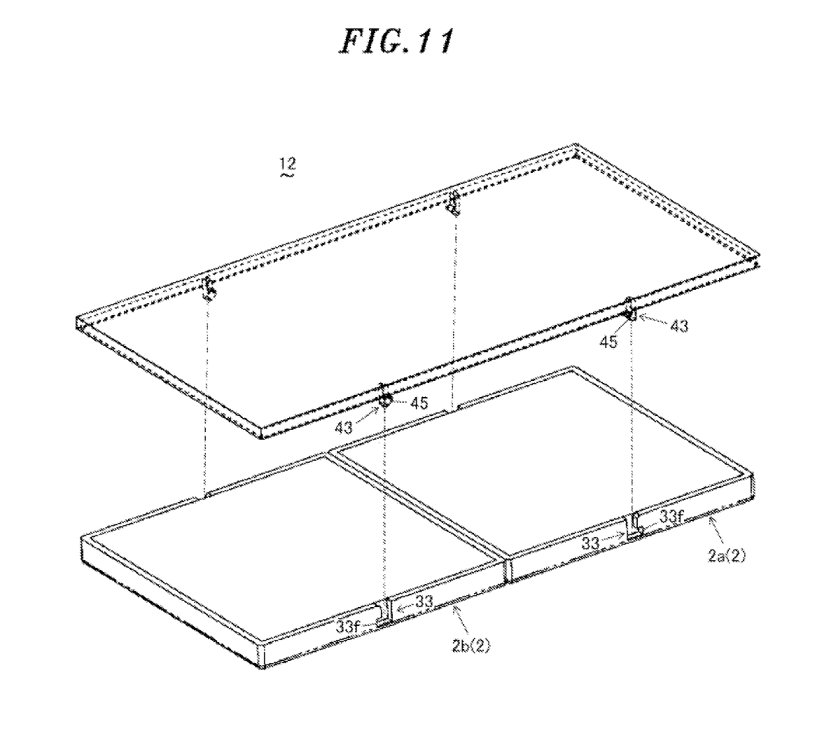

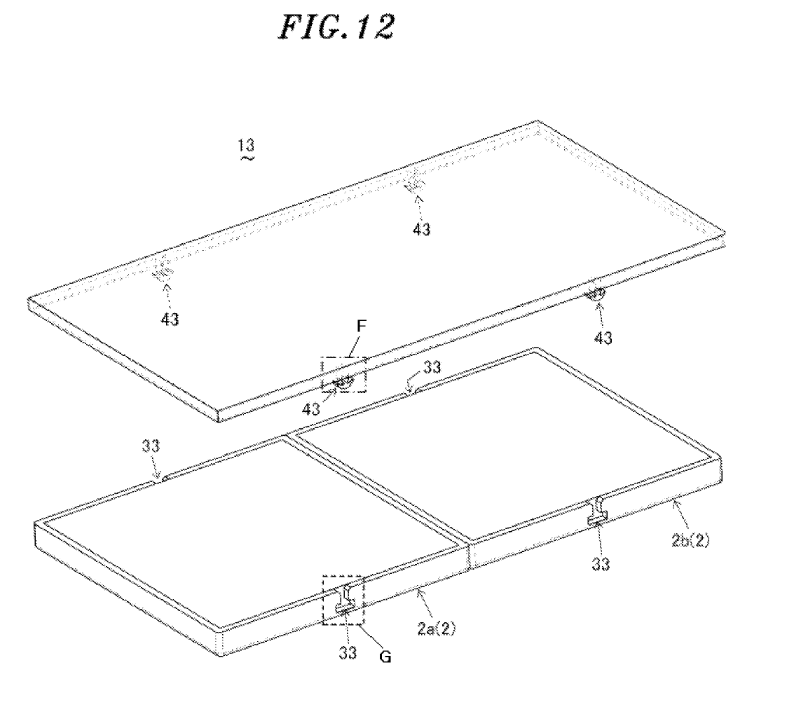

The light emitting module according to a third modified example will be described with reference to FIGS. 12 to 14B. As shown in FIG. 11, in the light emitting module 12 described above, if the positions of the light source units 2a and 2b are interchanged with each other, the orientation of the claw portion 45 of each of the attached portions 43 does not coincide with the orientation of the locking section 33f of each of the attaching portions 33. Thus, in this case, the optical cover 4 cannot be attached to the light source units 2a and 2b. In view of this, a light emitting module according to the third modified example of the aforementioned embodiment is configured such that the optical cover 4 can be attached to the light source units 2a and 2b regardless of the positions of the light source units 2a and 2b.

As shown in FIG. 12, the light emitting module 13 is based on the aforementioned light emitting module 12 with the shape of each of the attached portions 43 of the optical cover 4 and the shape of each of the attaching portions 33 of the light source units 2a and 2b changed.

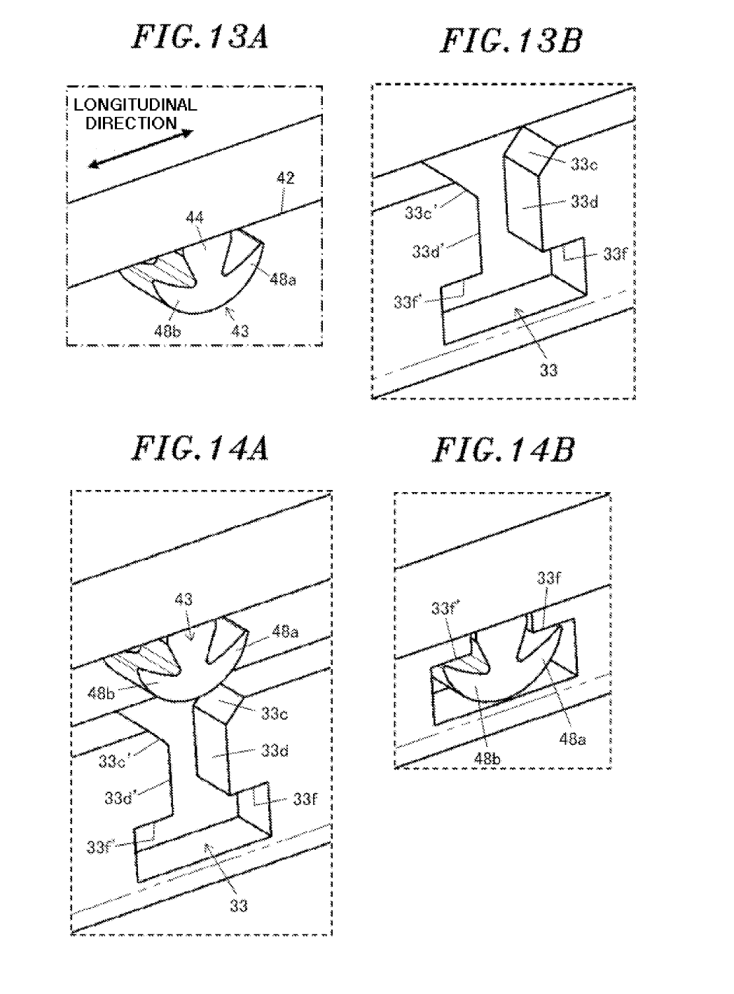

As shown in FIG. 13A, each of the attached portions 43 includes a pair of locking sections 48a and 48b extending from the lower end of the base portion 44 in the opposite directions along the longitudinal direction of the optical cover 4. The locking sections 48a and 48b are made of a material which can be elastically deformed when a specified stress is applied thereto. Each of the locking sections 48a and 48b is gradually thinned toward the tip thereof and is curved toward each of the leg portions 42. As shown in FIG. 13B, each of the attaching portions 33 includes a pair of slant sections 33c and 33c′, a pair of straight sections 33d and 33d′ and a pair of locking sections 33f and 33f′. The slant sections 33c and 33c′ are provided opposite to each other. The straight sections 33d and 33d′ are provided opposite to each other. The locking sections 33f and 33f′ are provided opposite to each other.

As shown in FIG. 14A, when attaching the attached portion 43 to the attaching portion 33, the attached portion 43 is first moved closer to each of the attaching portion 33 such that the locking sections 48a and 48b of the attached portion 43 make contact with the slant sections 33c and 33c′ of the attaching portion 33. Then, the locking sections 48a and 48b are pressed by the slant sections 33c and 33c′. The locking sections 48a and 48b are elastically deformed such that the attached portion 43 can pass through between the straight sections 33d and 33d′. Then, if the locking sections 48a and 48b reach the locking sections 33f and 33f′, the elastic deformation of the locking sections 48a and 48b is released such that the locking sections 48a and 48b engage with the locking sections 33f and 33f′ as shown in FIG. 14B.

According to the light emitting module 13 configured as above, it is possible to obtain the same effects as provided by the aforementioned light emitting module 1. In addition, the optical cover 4 can be attached to the light source units 2a and 2b regardless of the positions of the light source units 2a and 2b.

In the light emitting modules 1, 11, 12 and 13, each of the attached portions 43 is formed into a protruding shape and each of the attaching portions 33 is formed into a depressed shape. Conversely, each of the attached portions 43 may be formed into a depressed shape and each of the attaching portions 33 may be formed into a protruding shape.

### Second Embodiment

Conventionally, there is known an illumination device which includes a plurality of organic EL elements (light source units) and a substrate (base unit) for supporting the organic EL elements (see, e.g., Japanese Patent Unexamined Application Publication No. 2012-104504). The supply of electric power to the light source units is performed by inserting the electrodes of the light source units into the electrodes embedded in the base unit. In this illumination device, the electrodes of the light source units are kept inserted into the electrodes of the base unit after the light source units are mounted to the base unit. It is therefore impossible to move the light source units with respect to the base unit. In view of this, a light emitting module according to a second embodiment of the present invention seeks to make sure that, even after the light source units are mounted to the base unit, the light source units can be moved and position-adjusted with respect to the base unit.

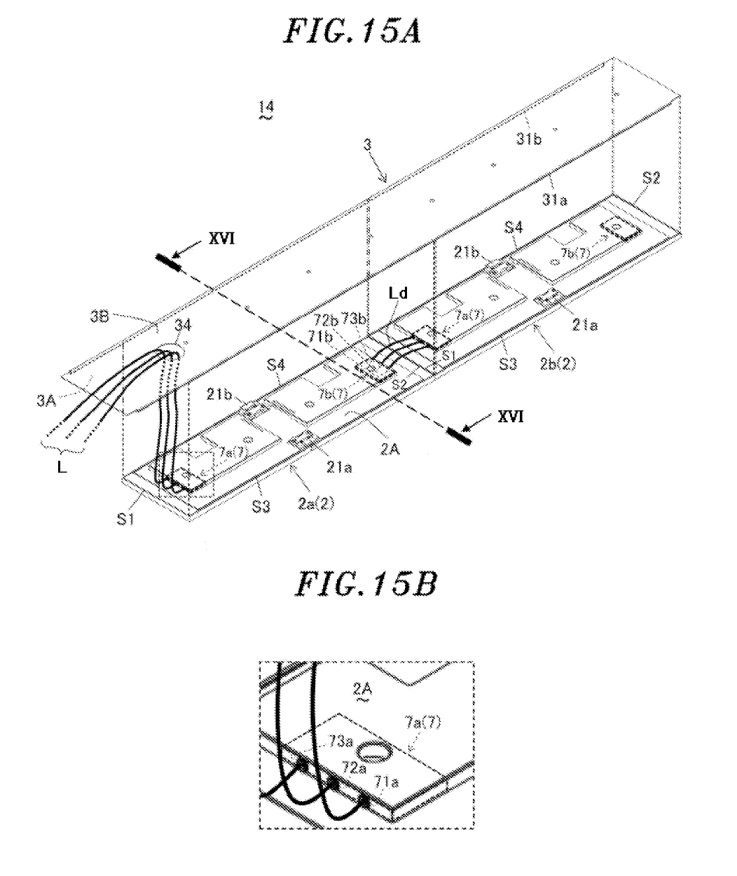

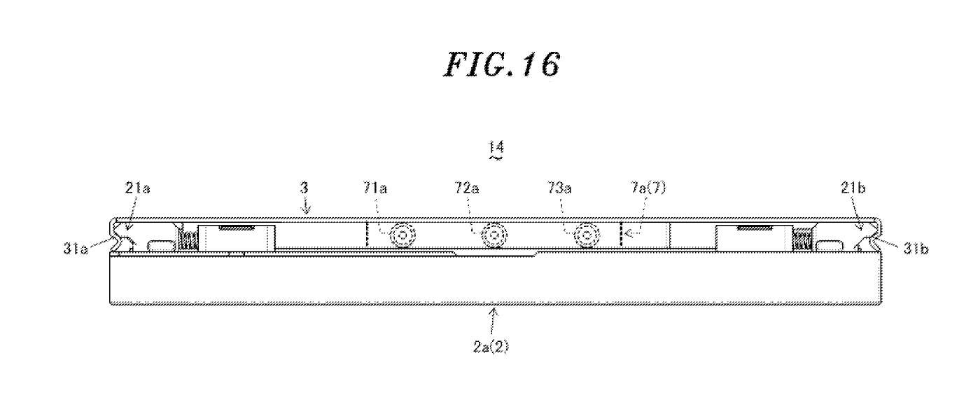

The light emitting module according to the second embodiment will be described with reference to FIGS. 15A to 17E. As shown in FIGS. 15A to 16, in the light emitting module 14, each of the light source units 2 includes terminal units 7 directly connected an anode line, a cathode line and a signal line (hereinafter sometimes collectively referred to as electric wires) or delivery lines Ld. In FIG. 16, the cross section is not hatched.

In the illustrated example, the light source units 2 include two light source units 2a and 2b having an elongated rectangular plate shape. The light source units 2a and 2b are disposed adjacent to each other with the short sides interposed therebetween. In the following description, one and the other short sides of the light source units 2a and 2b will be designated by S1 and S2. One and the other long sides of the light source units 2a and 2b will be designated by S3 and S4.

The terminal unit 7 includes an input terminal unit 7a provided in the side S1 and configured to input electric power and a dimming signal from the outside to each of the light source units 2a and 2b, and an output terminal unit 7b provided in the side S2 and configured to output electric power and a dimming signal from each of the light source units 2a and 2b to the outside. The input terminal unit 7a is disposed in the peripheral edge portion of the mounting surface 2A. The input terminal unit 7a includes electric wire insertion holes 71a, 72a and 73a into which an anode line, a cathode line and a signal line extending from the outside are inserted. The electric wire insertion holes 71a, 72a and 73a are arranged along a line parallel to the mounting surface 2A and are opened outward. The electric wire insertion holes 71a, 72a and 73a include electric wire reception portions (not shown) electrically connected to the electric wires inserted into the electric wire insertion holes 71a, 72a and 73a. The output terminal unit 7b is configured just like the input terminal unit 7a. The output terminal unit 7b includes electric wire insertion holes 71b, 72b and 73b. The electric wire reception portion of the electric wire insertion hole 71a and the electric wire reception portion of the electric wire insertion hole 71b are connected to each other by wiring patterns (not shown) provided in the light source units 2a and 2b. Similarly, the electric wire insertion holes 72a and 72b are connected to each other and the electric wire insertion holes 73a and 73b are connected to each other.

The electric wire extending from the outside and connected to the input terminal unit 7a of the light source unit 2a is drawn from the installation surface 3B toward the attachment surface 3A through a hole 34 formed in the base unit 3. The output terminal unit 7b of the light source unit 2a and the input terminal unit 7a of the light source unit 2b are connected to each other by delivery lines Ld.

Each of the light source units 2a and 2b includes a pair of engaging portions 21a and 21b provided in the sides S3 and S4 and formed into an identical shape with each other. The base unit 3 includes a pair of engaged portions 31a and 31b provided in the long sides thereof and formed into an identical shape with each other. The engaging portions 21a and 21b are engageable with the engaged portions 31a and 31b. After engaging with the engaged portions 31a and 31b, the engaging portions 21a and 21b are slidable along the engaged portions 31a and 31b.

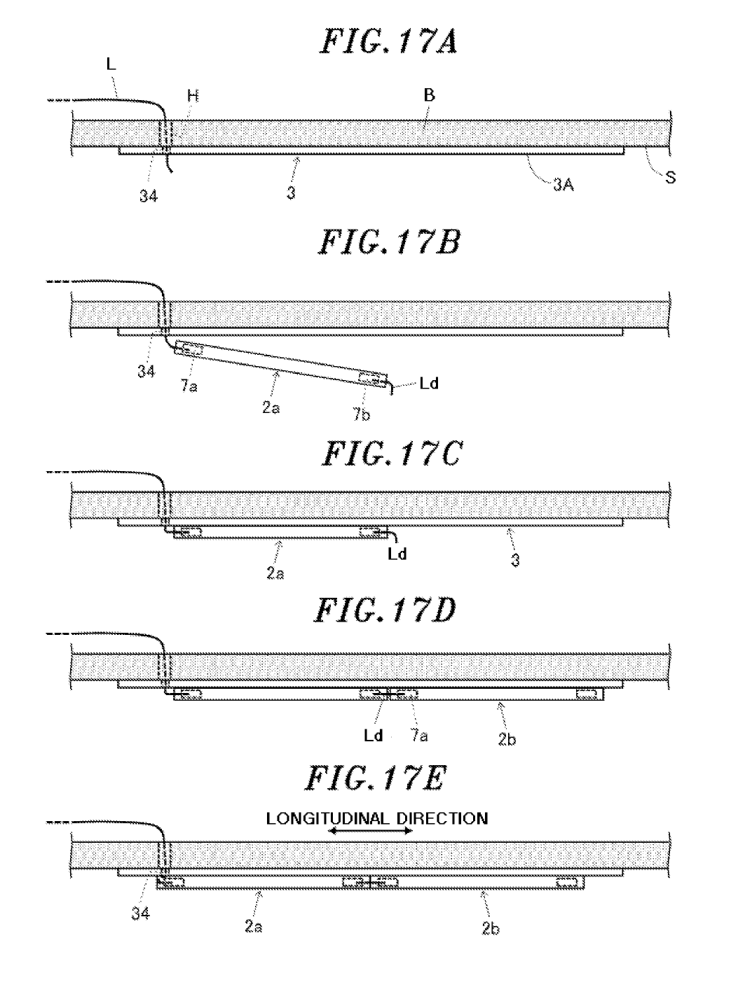

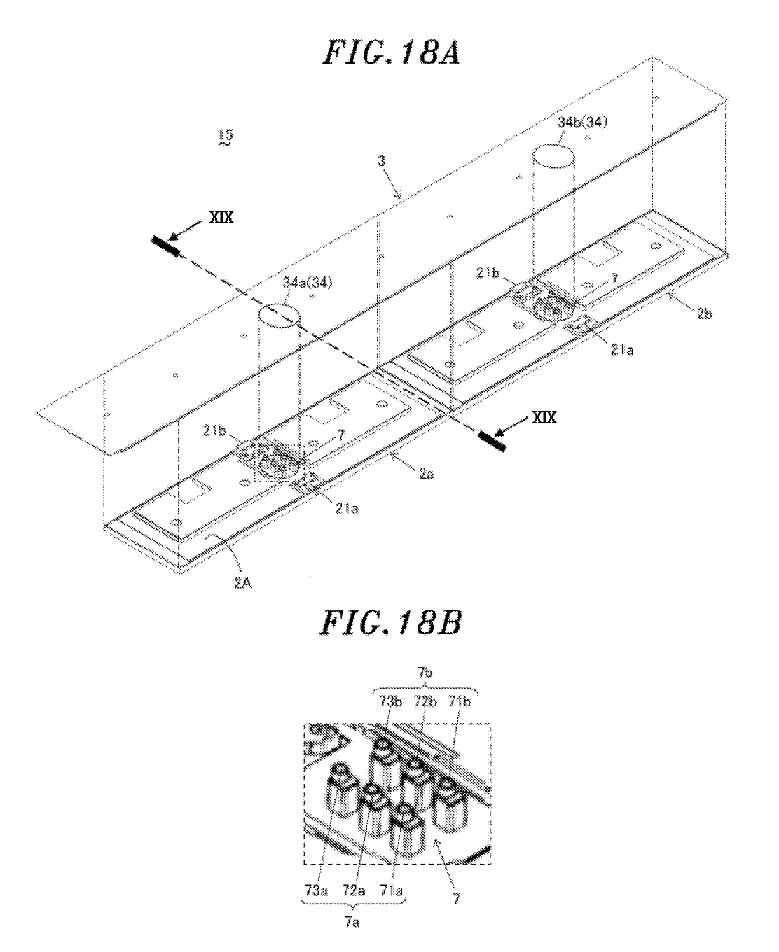

A procedure for attaching the light emitting module 14 having the aforementioned configuration to an installation place will be described with reference to FIGS. 17A to 17E. In these figures, for the sake of simplicity, the anode line, the cathode line and the signal line are indicated by a single electric wire L. First, as shown in FIG. 17A, the electric wire connected to the outside is drawn from the rear side of a wall B (indicated by dots) toward the attachment surface 3A through the hole 34 formed in the base unit 3 and the hole H formed in the wall B in a corresponding relationship with the hole 34. In this state, the base unit 3 is fixed to the installation place S. Then, as shown in FIG. 17B, the electric wire L drawn from the hole 34 is connected to the input terminal unit 7a of the light source unit 2a. One end of the delivery line Ld is connected to the output terminal unit 7b of the light source unit 2a. Thereafter, as shown in FIG. 17C, the light source unit 2a is mounted to the base unit 3. Subsequently, as shown in FIG. 17D, the other end of the delivery line Ld is connected to the input terminal unit 7a of the light source unit 2b. Then, the light source unit 2b is mounted to the base unit 3. Finally, as shown in FIG. 17E, the light source units 2a and 2b are slid along the longitudinal direction of the base unit 3, thereby adjusting the positions of the light source units 2a and 2b so as to hide the hole 34 with the light source units 2a and 2b.

As described above, according to the light emitting module 14, the light source units 2 are connected to the outside through the electric wire L. Furthermore, the engaging portions 21a and 21b can slide along the engaged portions 31a and 31b after the engaging portions 21a and 21b engage with the engaged portions 31a and 31b. For that reason, the positions of the light source units 2 with respect to the base unit 3 can be adjusted after the light source units 2 are mounted to the base unit 3. Moreover, the electric wire insertion holes 71a to 73a and 71b to 73b of the terminal units 7 are opened in the direction parallel to the mounting surface 2A. Therefore, when inserted into the electric wire insertion holes 71, 72 and 73, the electric wires are not bent in the thickness direction of the light source units 2a and 2b. This makes it possible to reduce the thickness of the light source units 2a and 2b. Since the engaging portions 21a and 21b are engageable with the engaged portions 31a and 31b, there is no need to consider the mounting direction of the light source units 2a and 2b to the base unit 3. This helps improve the operability.

Next, a light emitting module according to a modified example of the second embodiment will be described with reference to FIGS. 18A to 20D. As shown in FIGS. 18A and 18B, in the light emitting module 15, a terminal unit 7 is provided upright on the mounting surface 2A of each of the light source units 2a and 2b. The terminal unit 7 is formed by functionally unifying the input terminal unit 7a and the output terminal unit 7b of the light emitting module 14. The terminal unit 7 includes electric wire insertion holes 71a, 72a and 73a and electric wire insertion holes 71b, 72b and 73b electrically connected to the electric wire insertion holes 71a, 72a and 73a. The electric wire insertion holes 71a to 73a and 71b to 73b are opened in the direction orthogonal to the mounting surface 2A. The terminal unit 7 is disposed at a middle position between a pair of engaging portions 21a and 21b.

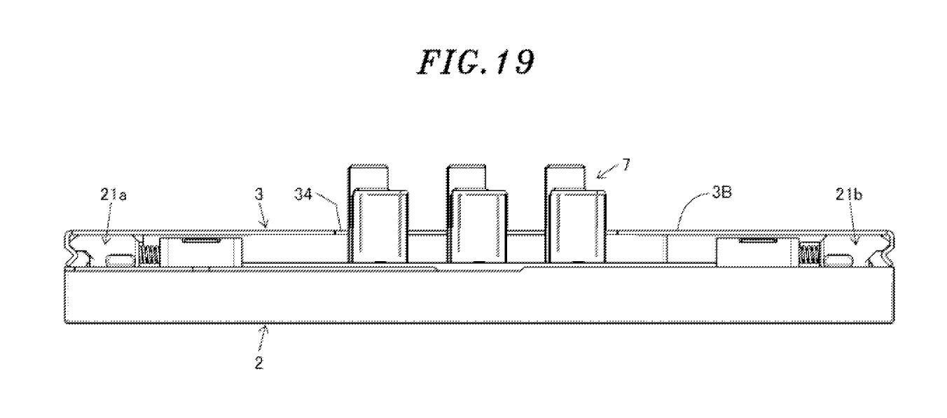

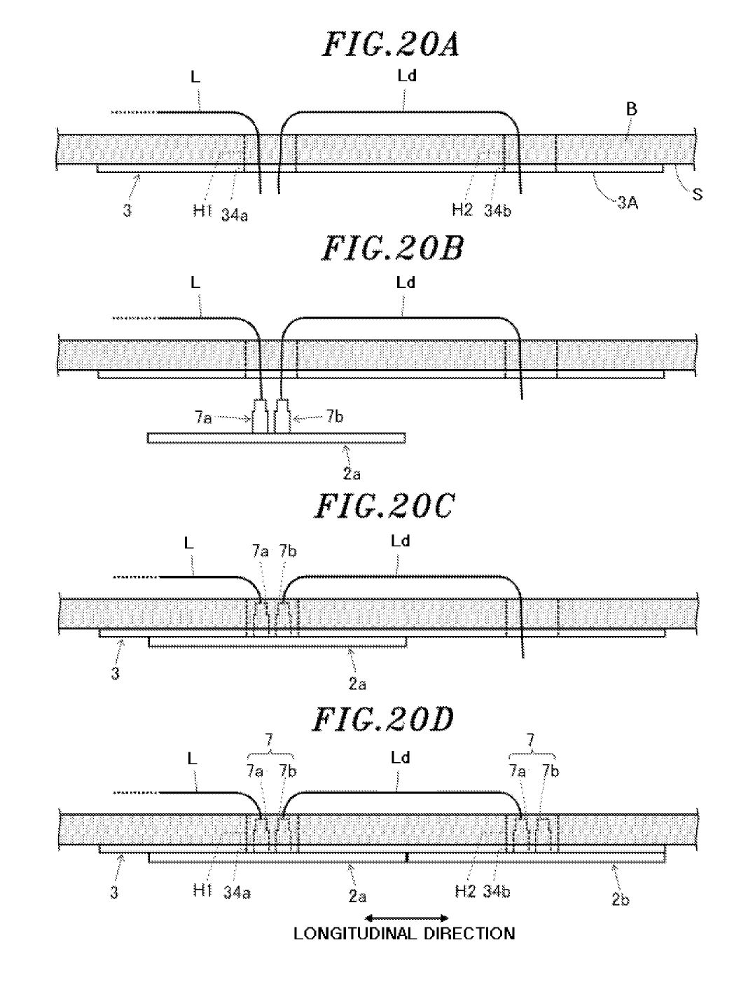

The hole 34 of the base unit 3 include holes 34a and 34b formed at the positions corresponding to the terminal units 7 of the light source units 2a and 2b when the light source units 2a and 2b are mounted to the base unit 3. In the illustrated example, the holes 34a and 34b are formed into a circular shape. The diameter of the holes 34a and 34b is larger than the outer diameter of the terminal unit 7. Therefore, if the light source units 2 are mounted to the base unit 3 as shown in FIG. 19, the terminal unit 7 protrudes beyond the installation surface 3B of the base unit 3 through the hole 34. In this regard, the terminal unit 7 is disposed at a middle position between the engaging portions 21a and 21b. Thus, even if the light source units 2 are mounted to the base unit 3 such that the engaging portions 21a and 21b respectively engage with the engaged portions 31b and 31a, the terminal unit 7 protrudes beyond the installation surface 3B as mentioned above. In FIG. 19, the cross section is not hatched.

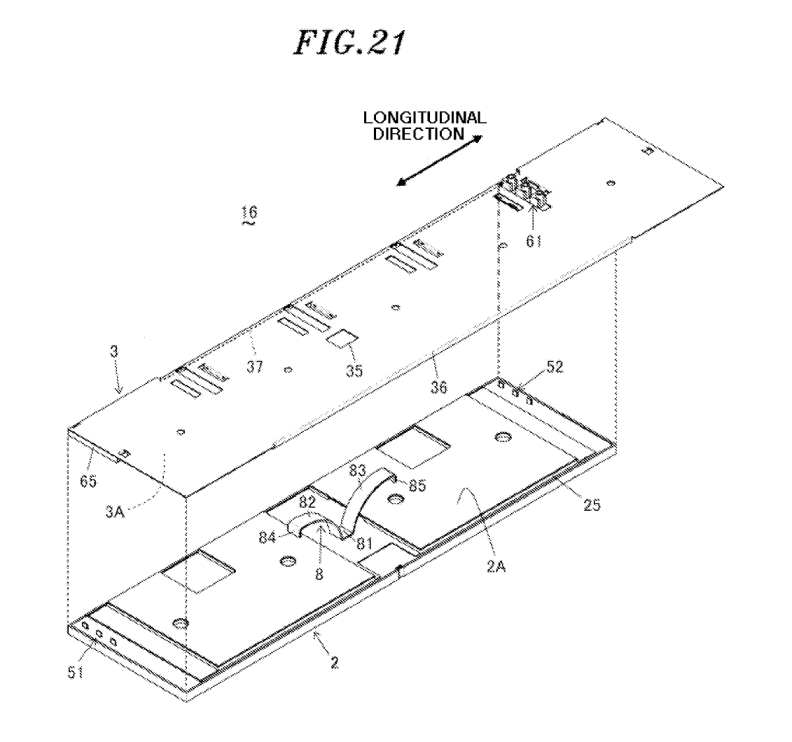

A procedure for attaching the light emitting module 15 having the aforementioned configuration to an installation place S will be described with reference to FIGS. 20A to 20D. First, as shown in FIG. 20A, one end of the electric wire L connected to the outside and one end of the delivery line Ld for electrically interconnecting the light source units 2a and 2b are drawn from the rear side of a wall B (indicated by dots) toward the attachment surface 3A through the hole 34a formed in the base unit 3 and the hole H1 formed in the wall B in a corresponding relationship with the hole 34a. Furthermore, the other end of the delivery line Ld is drawn from the rear side of the wall B toward the attachment surface 3A through the hole 34b formed in the base unit 3 and the hole H2 formed in the wall B in a corresponding relationship with the hole 34b. In this state, the base unit 3 is fixed to the installation place S. Then, as shown in FIG. 20B, the electric wire L is connected to the input terminal unit 7a of the light source unit 2a. One end of the delivery line Ld is connected to the output terminal unit 7b of the light source unit 2a. Then, as shown in FIG. 20C, the light source unit 2a is mounted to the base unit 3 such that the input terminal unit 7a and the output terminal unit 7b are put in the hole H1 and the hole 34a. Thereafter, as shown in FIG. 20D, the other end of the delivery line Ld is connected to the input terminal unit 7a of the light source unit 2b. The light source unit 2b is mounted to the base unit 3 such that the input terminal unit 7a and the output terminal unit 7b of the light source unit 2b are put in the hole H2 and the hole 34b. Finally, the positions of the light source units 2a and 2b are adjusted by sliding the light source units 2a and 2b along the longitudinal direction of the base unit 3 within an extent in which the terminal units 7 can move within the holes 34a and 34b or the holes H1 and H2.

As described above, according to the light emitting module 15, just like the aforementioned light emitting module 14, the positions of the light source units 2 with respect to the base unit 3 can be adjusted even after the light source units 2 are mounted to the base unit 3. Since the electric wire insertion holes 71a to 73a and 71b to 73b are opened in the direction orthogonal to the mounting surface 2A, it becomes easy to perform a work of connecting the electric wires L to the electric wire insertion holes 71a to 73a and 71b to 73b. When the light source units 2 are mounted to the base unit 3, the terminal units 7 protrude beyond the installation surface 3B of the base unit 3 through the holes 34a and 34b. Thus, if the holes 34a and 34b are aligned with the holes H1 and H2 of the installation place S, it is possible to embed the terminal units 7 on the wall B. Therefore, as compared with the aforementioned light emitting module 14 having the terminal units 7 within the light source units 2a and 2b, it is possible to further reduce the thickness of the light emitting module 15. Moreover, the terminal unit 7 is disposed at a middle position between the engaging portions 21a and 21b. Each of the engaging portions 21a and 21b is engageable with the engaged portions 31a and 31b. Therefore, there is no need to consider the mounting direction of the light source units 2a and 2b to the base unit 3. This helps enhance the operability.

### Third Embodiment

Conventionally, there is known an illumination device which includes a light source unit having a plate shape and a mounting unit (base unit) having a plate shape to which the light source unit is removably mounted (see, e.g., Japanese Unexamined Patent Application Publication No. 2012-199219). The light source unit includes an engaging portion and a holding portion provided at opposite ends of the surface thereof facing the base unit and used in mounting the light source unit to the base unit. The base unit includes an engaged portion and a held portion provided on the surface thereof facing the light source unit and configured to engage with the engaging portion and the holding portion of the light source unit. The engaged portion is configured to slide toward the held portion. In this illumination device, many different members, such as the engaging portion, the holding portion, the engaged portion and the held portion, are involved in mounting the light source unit to the base unit. Moreover, the engaged portion is configured to slide. Accordingly, the configuration of the illumination device is complex. In view of this, a light emit ting module according to a third embodiment of the present invention seeks to make sure that a light source unit can be removably mounted to a base unit with simple configuration.

The light emitting module 16 according to the third embodiment will be described with reference to FIGS. 21 to 25. In the illustrated example, one light source unit 2 having an elongated rectangular plate shape is mounted to a base unit 3 having an elongated rectangular plate shape.

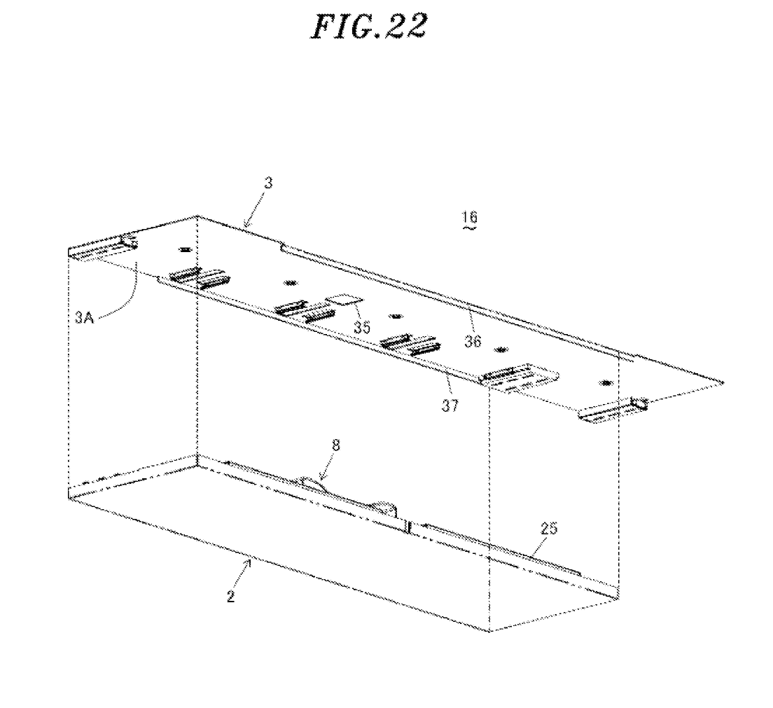

As shown in FIGS. 21 and 22, the light emitting module 1 6 does not include the engaging portion 21, the holding portion 22, the engaged portion 31 and the held portion 32 mentioned above but includes a leaf spring 8 disposed at the center of the mounting surface 2A of the light source unit 2 and used in mounting the light source unit 2 to the base unit 3. The leaf spring 8, which is formed into a substantially V-like shape, includes a base portion 81 fixed to the center of the mounting surface 2A, a pair of spring portions 82 and 83 extending from the base portion 81 in the opposite directions, and a pair of bent portions 84 and 85 provided at the leading ends of the spring portions 82 and 83 and bent toward the mounting surface 2A.

The base unit 3 includes a through-hole 35 which is formed on the attachment surface 3A at such a size as to pass therethrough the leaf spring 8 folded such that the spring portions 82 and 83 make contact with each other. The through-hole 3 5 is formed into a rectangular shape such that the respective sides of the through-hole 35 extend parallel to the respective sides of the base unit 3. The base unit 3 further includes a pair of wall portions 36 and 37 provided to extend along the long sides thereof and bent to the attachment surface 3A side. The wall portions 36 and 37 are used to align the base unit 3 and the light source unit 2 when mounting the light source unit 2 to the base unit 3 (see the description made later). The light source unit 2 includes protrusion portions 25 provided on the mounting surface 2A and configured to make contact with the inner surfaces of the wall portions 36 and 37 when the light source unit 2 is mounted to the base unit 3.

When mounting the light source unit 2 to the base unit 3, the leaf spring 8 folded such that the spring portions 82 and 83 make contact with each other is first inserted into the through-hole 35 of the base unit 3 at the side of the attachment surface 3A. If the leaf spring 8 is released at the time point when the spring portions 82 and 83 almost pass through the through-hole 35, the spring portions 82 and 83 are spread away from each other by the elastic forces thereof. Thus, the light source unit 2 is moved closer to the base unit 3. At this time, the wall portions 36 and 37 serve as guides such that the light source unit 2 are located at the right mounting position, because the wall portions 36 and 37 are provided in the base unit 3 and the protrusion portions 25 making contact with the inner surfaces of the wall portions 36 and 37 are provided in the light source unit 2. When removing the light source unit 2 from the base unit 3, the light source unit 2 is pulled away from the base unit 3 with a force overwhelming the elastic forces of the spring portions 82 and 83. Then, the aforementioned mounting process is performed in the reverse order.

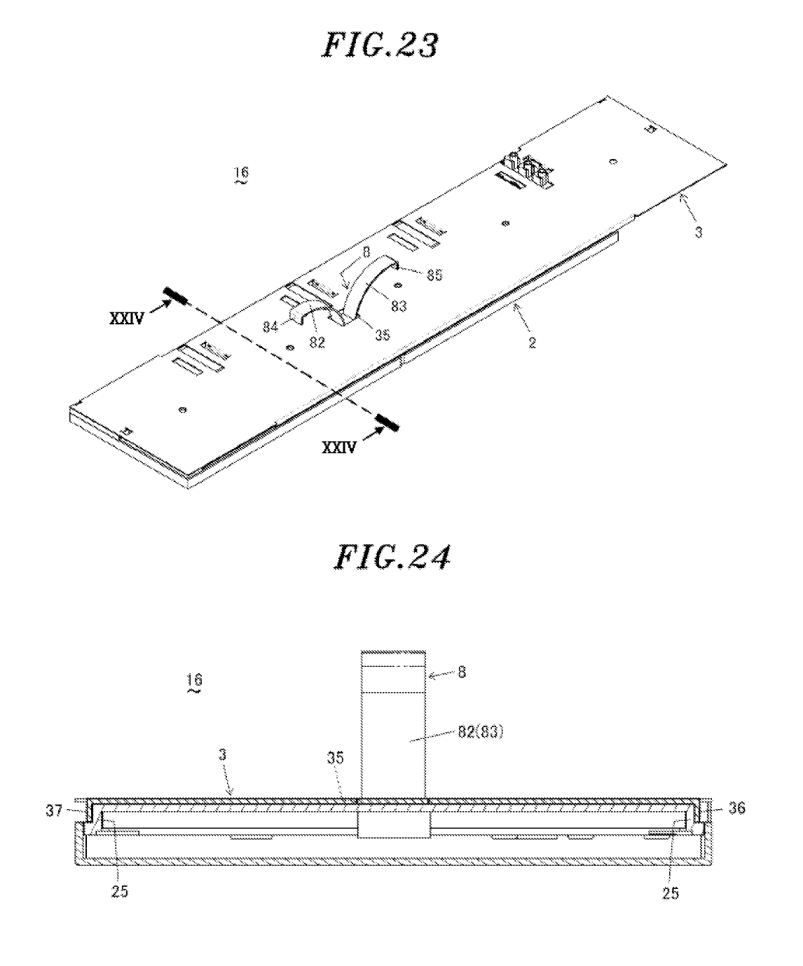

Thus, as shown in FIG. 23, the spread spring portions 82 and 83 serve as stoppers. The leaf spring 8 is not removed from the through-hole 35. Consequently, the light source unit 2 is mounted to the base unit 3. At this time, the spring portions 82 and 83 are disposed so as to extend along the longitudinal direction of the base unit 3. In this state, even if the spring portions 82 and 83 are folded again by the own weight of the light source unit 2 and the leaf spring 8 is pulled a way from the through-hole 35, the bent portions 84 and 85 are caught by the edge of the through-hole 35. Thus, the light source unit 2 is hardly removed from the base unit 3.

As described above, according to the light emitting module 16, the light source unit 2 can be removably mounted to the base unit 3 with a simple configuration using the leaf spring 8. Simultaneously with the mounting of the light source unit 2 to the base unit 3, the terminals 51 and 52 of the light source unit 2 are inserted into the input connector 61 and the end cap 65 of the base unit 3 (see FIG. 21). The insertion of the terminals 51 and 52 can be reliably performed because the wall portions 36 and 37 serve as guides such that the light source unit 2 is located at the right mounting position with respect to the base unit 3 and because the mounting of the base unit 3 to the light source unit 2 is performed at the front side.

As shown in FIG. 24, after the light source unit 2 is mounted to the base unit 3, the protrusion portions 25 make contact with the wall portions 36 and 37 and the spread spring portions 82 and 83 make contact with the inner surface of the through-hole 35. It is therefore possible to prevent misalignment of the light source unit 2 with respect to the base unit 3 and rotation of the light source unit 2 about the leaf spring 8 with respect to the base unit 3.

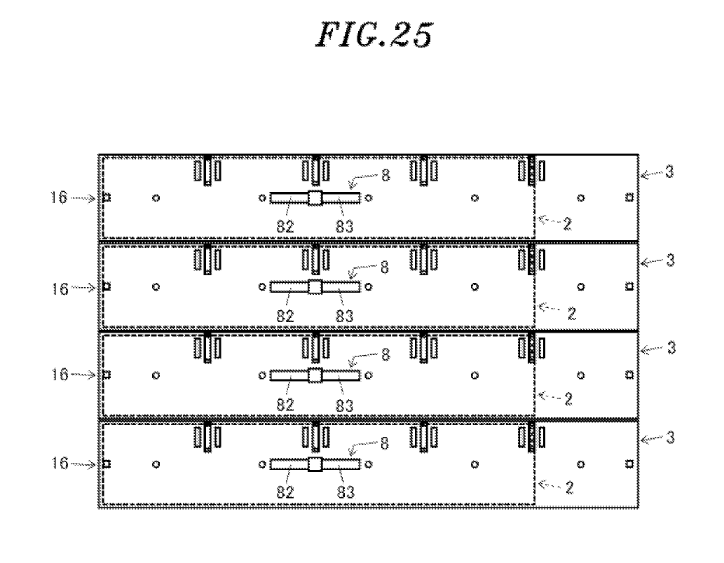

When the light source unit 2 is mounted to the base unit 3, the spring portions 82 and 83 extend along the longitudinal direction of the base unit 3. Therefore, even if a plurality of light emitting modules 16 is disposed adjacent to one another with the long sides interposed therebetween as shown in FIG. 25, the leaf springs 8 adjoining each other do not make contact with each other. Accordingly, for example, even when the light source unit 2 is made larger in size and in weight, it is possible to increase the size of the spring portions 82 and 83 without having to worry about the interference between the adjoining leaf springs 8. This makes it possible to reliably mount the light source unit 2 to the base unit 3.

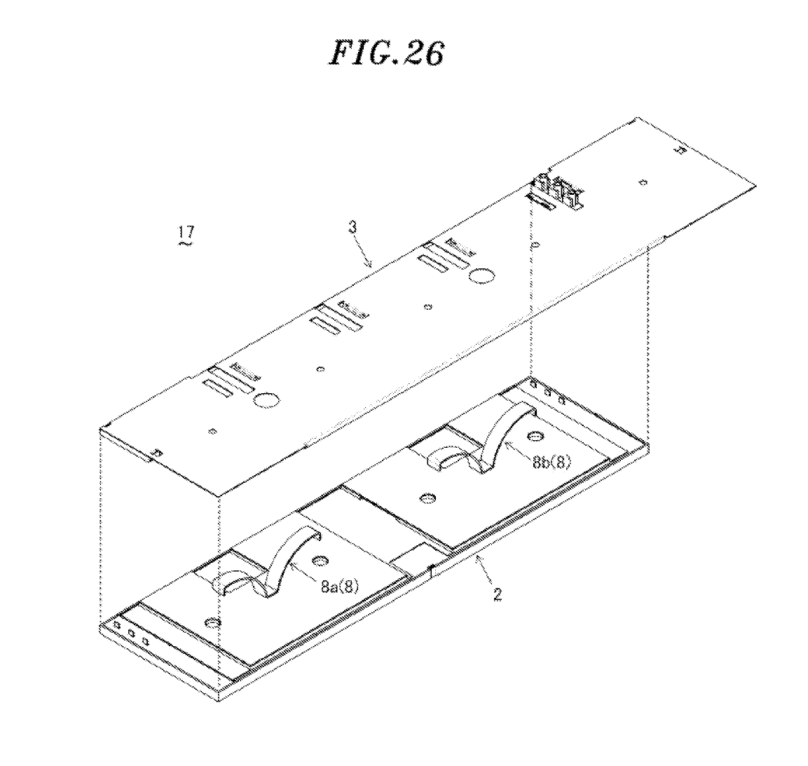

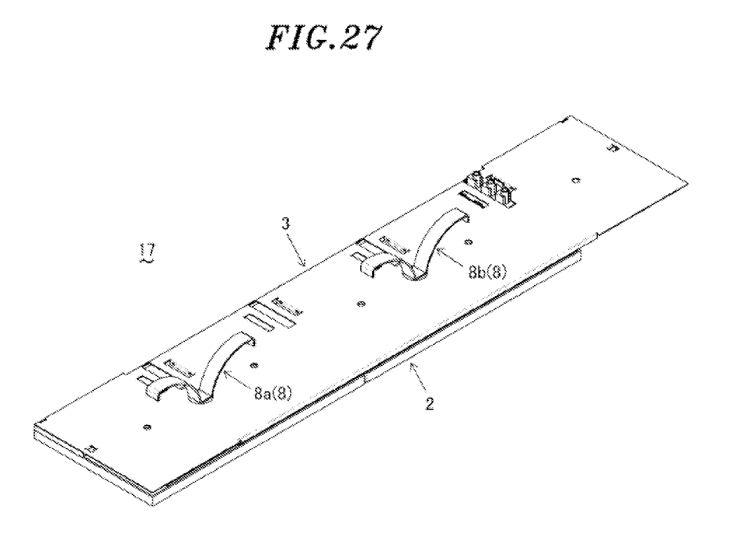

Next, a light emitting module according to a modified ex ample of the third embodiment will be described with reference to FIGS. 26 and 27. In the modified example 17, a plurality of leaf springs 8 is provided in one light source unit 2. In the illustrated example, two leaf springs 8a and 8b are provided in one light source unit 2. By providing two leaf springs 8a and 8b in this way, as compared with the aforementioned light emitting module 16, it is possible to accurately mount the light source unit 2 to the base unit 3 and to reliably prevent misalignment or rotation of the light source unit 2 with respect to the base unit 3.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light emitting module, comprising:
a plurality of light source units having a rectangular plate shape;
a base unit having an elongated rectangular plate shape, the light source units disposed along a straight line and mounted to the base unit; and
an optical cover configured to diffuse light emitted from the light source units, the optical cover having a rectangular shape when seen in a plan view and configured to cover the light source units,
wherein a length of each of sides of the optical cover and the light source units parallel to short sides of the base unit is substantially equal to a length of each of the short sides of the base unit.

2. The light emitting module of claim 1, wherein each of the light source units or the base unit includes an attaching portion used in attaching the optical cover, and the optical cover includes an attached portion detachably attached to the attaching portion.

3. The light emitting module of claim 2, wherein the optical cover is formed into an elongated rectangular shape with short sides thereof extending parallel to the short sides of the base unit and the attached portion is provided in each of long sides of the optical cover.

4. The light emitting module of claim 3, wherein the attached portion includes a claw portion engaging with the attaching portion, and the claw portion extends along each of the long sides of the optical cover.

5. An illumination device comprising:
the light emitting module of claim 1.

6. A light emitting module, comprising:
a light source unit having a rectangular plate shape; and
a base unit having a rectangular plate shape, the light source unit removably mounted to the base unit,
wherein the base unit includes an attachment surface to which the light source unit is attached, a pair of engaged portions provided to extend along two opposite sides of the attachment surface and used in holding the light source unit, and a through-hole formed in the attachment surface and configured to allow electric wires used in supplying electric power to the light source unit and delivering a dimming signal to the light source unit to pass through the through-hole from a rear side of the attachment surface,
the light source unit includes a terminal unit connected to the electric wires and a pair of engaging portions configured to engage with the engaged portions, the terminal unit and the engaging portions provided on a mounting surface of the light source unit to be mounted to the base unit, and
the engaging portions are slidable along the engaged portions after the engaging portions engage with the engaged portions.

7. The light emitting module of claim 6, wherein the terminal unit includes electric wire insertion holes into which electric wires are inserted, and the electric wire insertion holes are opened in a direction parallel to the mounting surface.

8. The light emitting module of claim 6, wherein the terminal unit includes electric wire insertion holes into which electric wires are inserted, and the electric wire insertion holes are opened in a direction orthogonal to the mounting surface.

9. The light emitting module of claim 8, wherein the terminal unit is provided upright on the mounting surface, and the through-hole is disposed at a position corresponding to the terminal unit when the light source unit is mounted to the base unit, the through-hole having a size larger than an outer size of the terminal unit.

10. The light emitting module of claim 9, wherein the terminal unit is disposed at a middle position between the engaging portions.

11. An illumination device comprising:
the light emitting module of claim 6.

12. A light emitting module, comprising:
a light source unit having a plate shape; and
a base unit having an elongated rectangular plate shape, the light source unit removably mounted to the base unit,
wherein the light source unit includes a mounting surface to be mounted to the base unit and at least one leaf spring provided on the mounting surface and used in mounting the light source unit to the base unit,
the at least one leaf spring has a substantially V-like shape and includes a base portion fixed to the mounting surface and a pair of spring portions extending from the base portion in opposite directions, and
the base unit includes an attachment surface to which the light source unit is attached and a through-hole formed in the attachment surface at such a size as to pass therethrough the leaf spring folded such that the spring portions make contact with each other.

13. The light emitting module of claim 12, wherein the through-hole is formed into a rectangular shape, and the through-hole includes sides extends parallel to a corresponding side of the base unit when the light source unit is mounted to the base unit.

14. The light emitting module of claim 12, wherein the spring portions extend along a longitudinal direction of the base unit when the light source unit is mounted to the base unit.

15. The light emitting module of claim 12, wherein the leaf spring further includes a pair of bent portions provided at leading ends of the spring portions and bent toward the mounting surface.

16. The light emitting module of claim 12, wherein the base unit includes a pair of wall portions extending along long sides of the base unit and bent toward the attachment surface side, and the light source unit includes protrusion portions provided on the mounting surface and configured to make contact with the wall portions.

17. The light emitting module of claim 12, wherein the at least one leaf spring includes a plurality of leaf springs provided in the light source unit.

18. An illumination device comprising:
the light emitting module of claim 12.
